(19) United States
(12) Patent Application Publication
(10) Pub. No.: US 2010/0115944 A1
(43) Pub. Date: May 13, 2010

(54) BOOST ASSIST DEVICE ENERGY CONSERVATION USING WINDMILLING

(75) Inventors: John Shutty, Clarkston, MI (US); Phil Keller, Clarkston, MI (US); Volker Joergl, Lake Orion, MI (US)

Correspondence Address: REISING, ETHINGTON, BARNES, KISSELLE, P.C., P. O. BOX 4390, TROY, MI, 48099-4390, US

(73) Assignee: BorgWarner Inc, Auburn Hills, MI (US)

(21) Appl. No.: 12/528,337

(22) PCT Filed: Feb. 27, 2008
(86) PCT No.: PCT/US08/55081

§ 371 Date: Aug. 24, 2009

Related U.S. Application Data
(60) Provisional application No. 60/891,765, filed on Feb. 27, 2007.

(51) Int. Cl. F02B 33/40; F02D 35/00; F02B 37/04

(52) U.S. Cl. 60/602; 123/559.1; 123/564; 60/607

(57) ABSTRACT

One embodiment includes windmilling a boost assist device by passing intake air through the boost assist device during operating modes where the device is not required to be operated (i.e., is not being actively powered). The windmilling effect will cause the boost assist device to rotate due to the windmilling effects of the air. This windmilling effect normally may not achieve full boost assist device operating speeds, but it will normally be sufficient to allow the boost assist device to avoid the high energy usage initial speed up phase of operation when the boost assist device is called upon to be actively powered. In one embodiment of the invention the windmilling conserves energy used to drive the boost assist device.

This application claims the benefit of U.S. Provisional Application No. 60/891,765 filed Feb. 27, 2007.

### TECHNICAL FIELD

The field to which the disclosure generally relates includes engine systems including a boost assist device.

### BACKGROUND

Several technologies are emerging to improve fuel economy, emissions and performance of internal combustion engine powered vehicles. One of these technologies involves the addition of air boost assist devices. Examples of these boost assist devices include hydraulically driven devices, electrically driven devices, belt driven devices and pneumatically driven devices. These devices may be driven directly from the engine, such as with a belt or via a hydraulic pump (which may be driven by the engine), or via an alternator (which is driven by the engine). Alternatively, a boost assist device may be driven by stored energy such as in an accumulator or a set of batteries. In any case, the economical usage of energy (especially stored energy) is of primary importance due to sizing considerations, fuel economy considerations and performance considerations.

One of the factors that can have a significant impact on the efficient use of energy with these types of devices is the initial speed up of the boost assist device. This initial speedup can consume a significant amount of energy due to the need to overcome the inertia of the device and/or because the efficiency of the boost assist device at low speeds is often very poor.

### SUMMARY OF EXEMPLARY EMBODIMENTS OF THE INVENTION

One embodiment of the invention includes windmilling a boost assist device by passing intake air through the boost assist device during operating modes where the device is not required to be operated (i.e., is not being actively powered). The windmilling effect will cause the boost assist device to rotate due to the windmilling effects of the air. This windmilling effect would normally not achieve full boosting device operating speeds, but will normally be sufficient to allow the boost assist device to avoid high energy usage during any initial speed up phase of operation when the boost assist device is called upon to be actively powered. In one embodiment of the invention the windmilling conserves energy used to drive the boost assist device.

Another embodiment of the invention includes increasing the windmilling effect and the speed of the rotating boost assist device by positioning an intake air swirl device at an inlet of the boost assist device.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the invention will become more fully understood from the detailed description and the accompanying drawings, wherein:

FIG. 1 is a schematic diagram of an engine system according to one embodiment of the invention.

FIG. 2 is a logical flow chart illustrating a method of operating an engine system according to one embodiment of the invention.

FIG. 3 is a chart illustrating the change over time of engine speed, boost assist device speed, energy input to the boost assist device, and bypass valve position in an engine system operated without windmilling the boost assist device.

FIG. 4 is a chart illustrating the change over time of engine speed, boost assist device speed, energy input to the boost assist device, and bypass valve position in an engine system operated by windmilling the boost assist device according to one embodiment of the invention.

FIG. 5 is a chart illustrating the change over time of engine speed, boost assist device speed, energy input to the boost assist device, and bypass valve position in a system operated by selectively windmilling the boost assist device during selective operating regions of an engine system according to one embodiment of the invention.

FIG. 6 illustrates a boost assist device according to one embodiment of the invention.

FIG. 7 is a perspective view of an intake air swirl device suitable for positioning in an inlet of a boost assist device to increase windmilling effect and rotation of the boost assist device according to one embodiment.

FIG. 8 is another view of the intake air swirl device of FIG. 7.

FIG. 9 illustrates a portion of an engine system according to one embodiment of the invention.

FIG. 10 illustrates a portion of an engine system according to another embodiment of the invention.

FIG. 11 illustrates another embodiment of the invention.

### DETAILED DESCRIPTION OF EXEMPLARY EMBODIMENTS

The following descriptions of the embodiments are merely exemplary in nature and are in no way intended to limit the invention, its application, or uses.

One embodiment of the invention includes windmilling a boost assist device by passing intake air through the boost assist device during operating modes where the device is not required to be operated (i.e., is not being actively powered). Doing this will cause the boost assist device to rotate due to the windmilling effects of the air. This windmilling effect normally may not achieve full boost assist device operating speeds, but will normally be sufficient to allow the boost assist device to avoid high energy usage during an initial speed up phase of operation when the boost assist device is called upon to be actively powered. In one embodiment of the invention the windmilling conserves energy used to drive the boost assist device.

Reducing the energy usage during initiation of an active power operating mode reduces the total energy usage of the boost assist device. This leads to the ability to reduce the size of the boost assist device (smaller energy storage, smaller drive system). It also helps improve energy efficiency and thus fuel economy. It can also help to improve system performance because the boost assist device achieves its target speed quicker.

Because the added restriction of a boost assist device in an inlet line to an engine can, under certain conditions, have a negative effect on engine operation, this operating mode may be utilized when the net effect on the overall engine system is positive. For example, when the engine is operating at full power, it may be desirable to not windmill the boost assist device as this may lead to an excessive restriction in the inlet line to the engine. In addition, the boost assist device would not need to be activated as the engine is transitioning out of this full engine power mode, so the initial state of the boost assist device is not critical (and hence windmilling to speed it up is unnecessary).

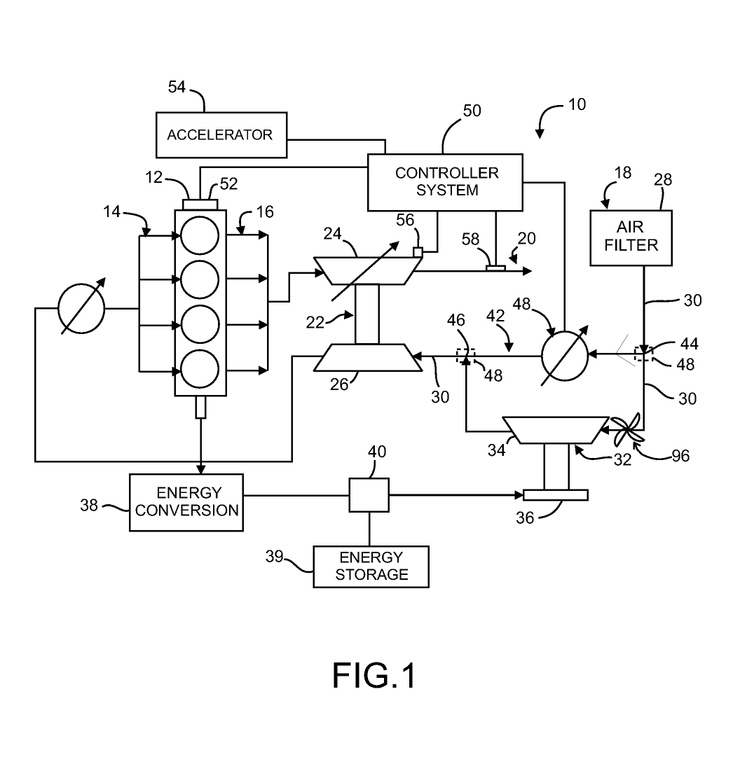

Referring now to FIG. 1, one embodiment includes an engine system 10 which may include one or more components as described hereafter. The engine system 10 may be used in a vehicle, such as an automobile or truck. In one embodiment, the engine system 10 may include an engine 12 such as, but not limited to, a diesel, gasoline or other combustible fuel engine. An air intake system 14 may include components and devices located upstream of the engine 12. For example, the air intake system 14 may include plumbing connected to the engine 12 at one end and the plumbing may include an open end 18. As used herein, the term plumbing includes any suitable conduit, tubes, hoses, passages, or the like. An optional air filter or cleaner 28 may be provided in the air intake system 14 at or near the open end 18 thereof.

An exhaust system 16 may be connected to the engine 12 to exhaust combustion gases out an open end 20 thereof. Optionally, a turbocharger 22 may be provided including a turbine 24 constructed and arranged to be turned by exhaust gas flowing through the plumbing of the exhaust system 16. The turbocharger 22 may include a compressor 26 operatively connected to the turbine 24 for turning the compressor 26 to deliver compressed air through the intake system 14 plumbing to the engine 12.

The air intake system 14 may include an air intake line 30 including a first segment 30′ which may extend from the open end 18 of the air intake system 14 plumbing to the turbocharger compressor 26. A boost assist device 32 may be provided in the first segment 30′ and may be constructed and arranged to assist the turbocharger compressor 26 by selectively delivering compressed air through the air intake system 14 to the compressor 26 and to the engine 12. The boost assist device 32 may include a drive mechanism 36 to receive any suitable drive power, and a compressor 34 coupled to and driven by the drive mechanism 36.

A bypass line 42 may be provided to provide bypass air through a path bypassing the boost assist device 32. In one embodiment of the invention, the bypass line 42 may be connected to the air intake line 30 at a first point 44 and at a second point 46.

A valve 48, such as a bypass valve, may be provided, preferably in the bypass line 42, and may be constructed and arranged to fully or partially open and/or close to allow, prevent, or meter the flow of air through the bypass line 42. As used herein the term close includes fully closed, and/or partly closed such that the valve 48 is also partly open. Likewise, the term open includes fully open, and/or partly open such that the valve is also partly closed. When the valve 48 is closed, air is forced to pass through the boost assist device 32 thereby windmilling the boost assist device 32.

In an alternative embodiment, the valve 48 may be a 3-way valve positioned at the first point 44 or the second point 46. When positioned at the first point 44, the valve 48 is constructed and arranged to have one inlet port and two outlet ports. In this location, the valve 48 may be operated to allow flow through the bypass line 42 to the engine 12 and/or through the boost assist device 32, or to close both outlet ports to stop flow though the bypass line 42 and through the boost assist device 32, for example, to brake the engine 12. When the 3-way valve 48 is positioned at the second point 46 the valve 48 has two inlets and one outlet, and functions similarly.

The engine system 10 may also include a controller system 50 constructed and arranged to control the valve 48 to fully open one or more of the inlet and outlet ports of the valve 48, fully close any one or more inlet and outlet ports or to partially open or close any one or more of the inlet and outlet ports. The controller system 50 may be the same as or separate from the controller used to control the engine 12. In one embodiment of the invention, the controller system 50 may control the valve 48 in response to a variety of input signals or data collected from sensors and like devices such as, but not limited to, an engine speed sensor 52, an accelerator pedal position sensor 54, a turbocharger component speed sensor 56, and/or an exhaust sensor 58. The controller system 50 may include any suitable processing device(s) for executing computer readable instructions or the like, and any suitable memory device(s) coupled to the processing device(s) for storing data and computer readable instructions. For example, engine speed data may be collected over time and stored in the memory device and later used to determine whether to windmill the boost assist device 32. The valve 48 may be controlled based on information regarding the current engine speed and/or the engine speed that was recently collected in the past. Illustrative examples of using such signals and/or data to control the valve 48 will be provided hereafter. The controller system 50 may control the valve 48 based on information obtained representative of the engine load which may be directly measured or calculated or estimated from the fuel being commanded to the fuel injectors from the engine controller, from the throttle position, boost or MAP sensors, or the turbocharger compressor speed or from any of a variety of actuator command signals (e.g., fueling, VTG, etc.)

Optionally, a swirl device 96 may be provided at or near the inlet of the boost assist device 32 as will be described in detail hereafter. The swirl device 96 swirls air entering the boost assist device 32 to enhance windmilling.

The engine system 10 may also include an energy conversion device 38 for example for converting mechanical energy from the engine 12 to electrical energy, hydraulic energy, pneumatic energy, etc. Suitable energy routing devices 40 may be provided, such as valves, switches, and the like. Also, energy storage devices 39 such as batteries, accumulators, or the like may be provided.

Referring now to FIG. 9, in another embodiment of the invention the bypass line 42 may have an end 18′ open to the atmosphere to provide an air path from the open end 18′ through the bypass line 42 to the turbocharger compressor 26 or engine 12. Preferably the end 18′ that is open to the atmosphere is connected to the same or a different air filter as the end 18. A 3-way valve 48 may have a first inlet port (not shown) connected to the bypass line 42 and one outlet port connected by plumbing to the turbocharger compressor 26 or engine 12. The 3-way valve 48 also includes a second inlet port (not shown) connected to the first segment 30.

The valve 48 may be controlled in any suitable manner. For example, the valve 48 may be controlled so that the second inlet port (connected to the bypass line 42) may be open at times when the windmilling effect would have a negative effect on the engine 12, for example, when the engine 12 is at high load and speed and the first inlet port may be fully open. Also, the valve 48 may be controlled so that the first inlet port (connected to the first segment 30′ including the boost assist device 32) may be may be fully closed and the second inlet port (connected to the bypass line 42) fully open to enhance the windmilling effect on the boost assist device 32 for example when the engine 12 is at idle. The valve 48 may be controlled to partially open either or both of the first and second inlet ports. The valve 48 may also be controlled to close both inlet ports to brake the engine if desired.

Referring now to FIG. 10, in a further embodiment of the invention, the bypass line 42 may have an end 18′ open to the atmosphere to provide an air path from the open end 18′ through the bypass line 42 to the turbocharger compressor 26 or engine 12. A valve 48 may be provided in the bypass line 42 to permit or prevent air from flowing therethrough. A first segment 30′ is provided and is separate from the bypass line 42. A boost assist device 32 may be provided in the first segment 30. The first segment 30′ is connected to the turbocharger compressor 26 or engine 12 at one end and open to the atmosphere at another end 18. A valve 48′ is provided in the first segment 30.

The valves 48, 48′ may be controlled in any suitable manner.

For example, the valve 48′ may be open and the other valve 48 closed, when windmilling is desired, for example when the engine 12 is at idle. Also, the valve 48′ may be closed, and the other valve 48 open, when windmilling is not desired, for example when the engine 12 is at high load or speed or when the engine 12 is transitioning from a higher speed to a lower speed. Furthermore, both valves 48 and 48′ may also be controlled to close to brake (or stop) the engine 12 if desired, or to partially open to more freely control windmilling.

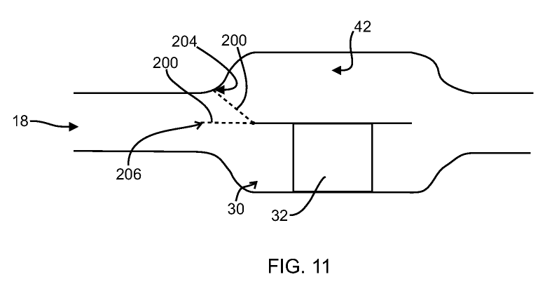

In yet another embodiment shown in FIG. 11, the first segment 30′ and the bypass line 42 may be defined by a common conduit with a divider therebetween, the boost assist device 32 in the first segment, and a flap valve 200 at an upstream or downstream end of the divider. In operation, the flap valve can be moved to at least two positions: a full boost position 204 to block airflow through the bypass line 42 and, thus, force all airflow through the boost assist device 32; and a partial boost or partial bypass position 206 to meter airflow through both the bypass line 42 and the boost assist device 32. Unlike the embodiments with a three-way valve, however, the flap valve 200 does not block all airflow to brake the engine 12.

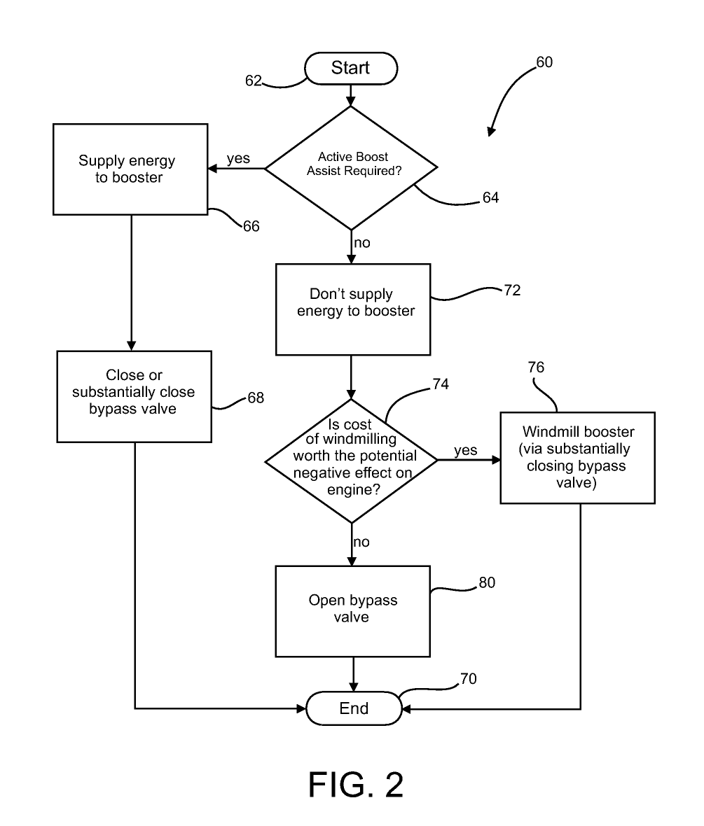

FIG. 2 is a logic flow chart 60 illustrating a simplified algorithm that may be used to control the engine system 10 to selectively provide the windmilling operation according to one embodiment of the invention. The algorithm may be stored in suitable memory within the controller system 50 and may be executed by any suitable processor therein. The algorithm describes an approach where during modes of active boost assist, no windmilling is done. When not actively driving the boost assist device 32, the algorithm decides if the cost of windmilling (i.e., the added inlet restriction) would be worth the potential benefit of having a spinning booster. If so, then the bypass valve 48 is closed and windmilling of the boost assist device is accomplished. Note that alternatively, one could provide a more continuous control of the bypass valve position. For example, under conditions where windmilling would be very beneficial (e.g., under operating conditions where boost assist is likely to be needed in the near future (near idle)) and the cost of windmilling is small or even negative (e.g., during in-gear braking) then the bypass valve 48 may be fully closed. Under conditions where boost assist is not likely to be needed in the near future (e.g. operating at high engine speed already) and the engine 12 would be impacted negatively by windmilling (e.g. at high load) then the bypass valve 48 may be fully opened. In intermediate situations where windmilling is only somewhat likely and there are only small negative impacts on the engine 12, then the valve 48 may be set to some partially closed position which would provide some windmilling but at a reduced impact on the engine operation.

Referring now specifically to the flow chart 60 shown in FIG. 2, a method according to one embodiment may include a start point 62. A first step 64 may include determining whether active boost assist is required. If yes, a second step 66 may include driving the boost assist device 32 by supplying energy to the drive mechanism 36 of the boost assist device 32 to drive the boost assist device compressor 34. The energy supplied may be mechanical, electrical, pneumatic and/or hydraulic. Optionally, a third step 68 may include closing or substantially closing the valve 48 so that intake air flows substantially only through the boost assist device 32. If boost assist is not required, a fourth step 72 is to not supply energy to the boost assist device 32. A fifth step 74 is determining whether windmilling the boost assist device 32 is worth the potential negative effect on the engine 12. If yes, a sixth step includes windmilling the boost assist device 32 by closing or substantially closing the valve 48 in the bypass line 42. If not, a seventh step 80 includes opening the valve 48 in the bypass line 42. Thereafter the method be repeated and may end at step 70.

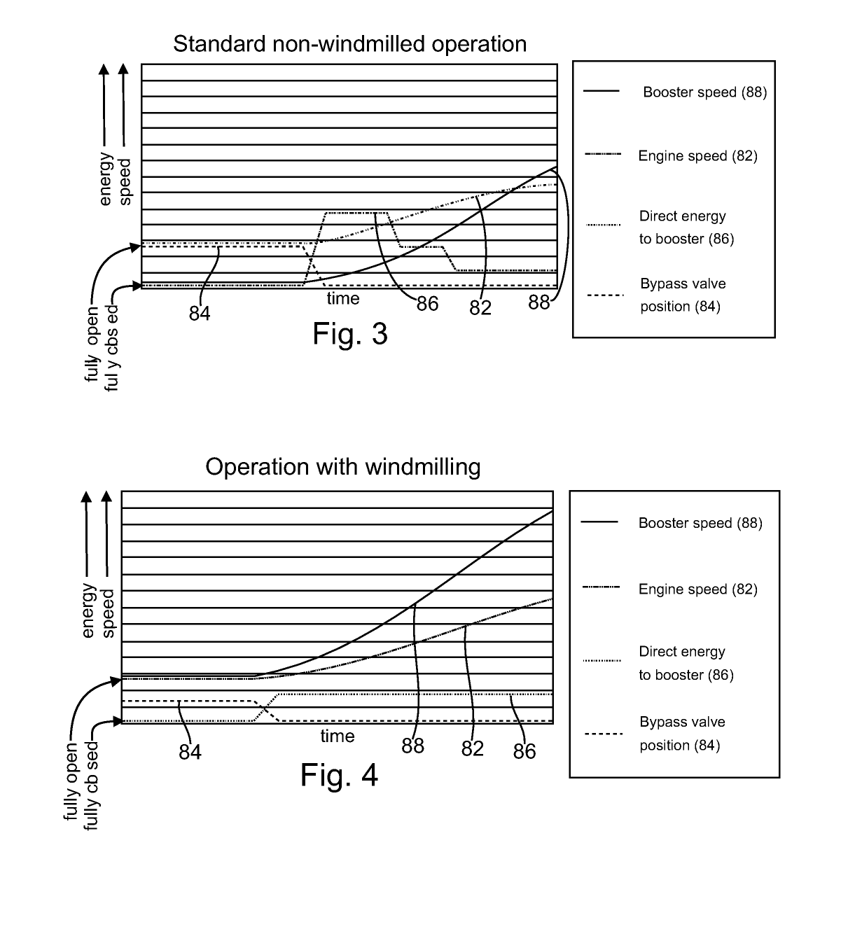

FIG. 3 is a chart illustrating the change over time of engine speed 82, boost assist device speed 88, energy input 86 to the boost assist device, and bypass valve position 84 in the engine system 10 operated without windmilling the boost assist device 32. FIG. 3 is an example plot showing boost assist device rotational speed during engine operation using a standard non-windmilling approach. Engine speed 82 and active energy input 86 to the booster is also shown. As can be seen, a large amount of energy is used to start the boost assist device 32 spinning from 0 RPM. The boost speed comes up relatively slowly due to the inefficiency at low speeds and the engine speed increases relatively slowly due to the lower boost available to it.

FIG. 4 is a chart illustrating the change over time of engine speed 82, boost assist device speed 88, energy input 86 to the boost assist device, and bypass valve position 84 in the engine system 10 operated by windmilling the boost assist device 32 according to one embodiment of the invention. FIG. 4 shows a similar area of engine operation as in FIG. 3 but wherein windmilling of the boost assist device 32 is utilized according to one embodiment of the invention. When the valve 48 is in a position that causes all or a percentage of the intake air to pass through the boost assist device 32 (fully closed or partially closed (as is the case in the figure)) during the initial non-energized portion of operation (1-9 seconds) the boost assist device speed is non-zero. When energy is applied directly to the boost assist device 32, a smaller amount of energy is required. Also, the boost assist device 32 accelerates more quickly due to the better efficiency. Finally, the engine speed increases more quickly due to the faster availability of more air.

The example plot of FIG. 4 is illustrative of some efficiency gains and some response performance gains. Of course in practice, the engine system 10 may be tuned to gain maximum performance (e.g. still use large initial energy, but spin the boost assist device 32 faster) or it may be tuned for maximum efficiency (e.g. input much less energy so that the baseline engine response is achieved but with much less energy), or again, some compromise of the two.

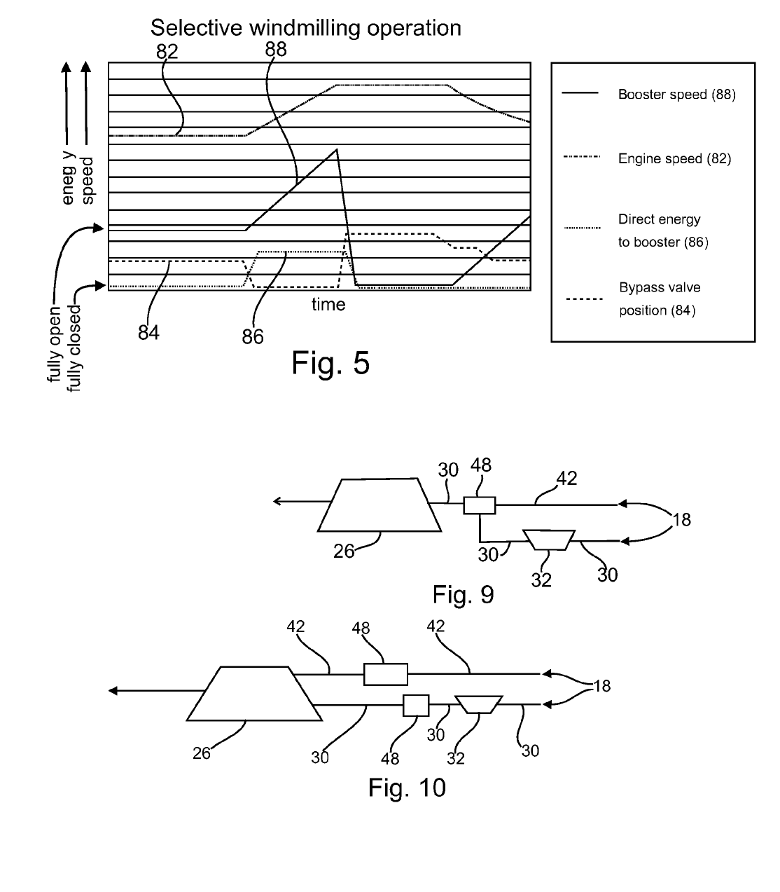

FIG. 5 is a chart illustrating the change over time of engine speed 82, boost assist device speed 88, energy input 86 to the boost assist device, and bypass valve position 84 in the engine system 10 operated by selectively windmilling the boost assist device during selective operating regions of the engine 12 according to one embodiment of the invention. FIG. 5 shows an operating mode where, initially, direct power to the boost assist device 32 is turned off and then the valve 48 is fully open. As noted previously, this may be a situation in which the added restriction of the boost assist device 32 in the inlet air stream is overly detrimental to the efficient operation of the engine 12. It may also be a situation in which the engine 12 is in an operating region which has no direct path to another operating region where active operation of the boost assist device 32 is required. The engine 12 will need to first pass through another operating region where the boost assist device 32 can then be windmilled, before it will be required to be actively driven. For example, the engine 12 may be operating at high load and speed, wherein boost assist may not be needed. The engine 12 will need to go through a deceleration period before driving of the boost assist device 32 is required again. So, as long as the engine 12 remains at high load and speed, the valve 48 can remain open. As the engine 12 decelerates, the valve 48 may begin to close in preparation of the next active boosting event.

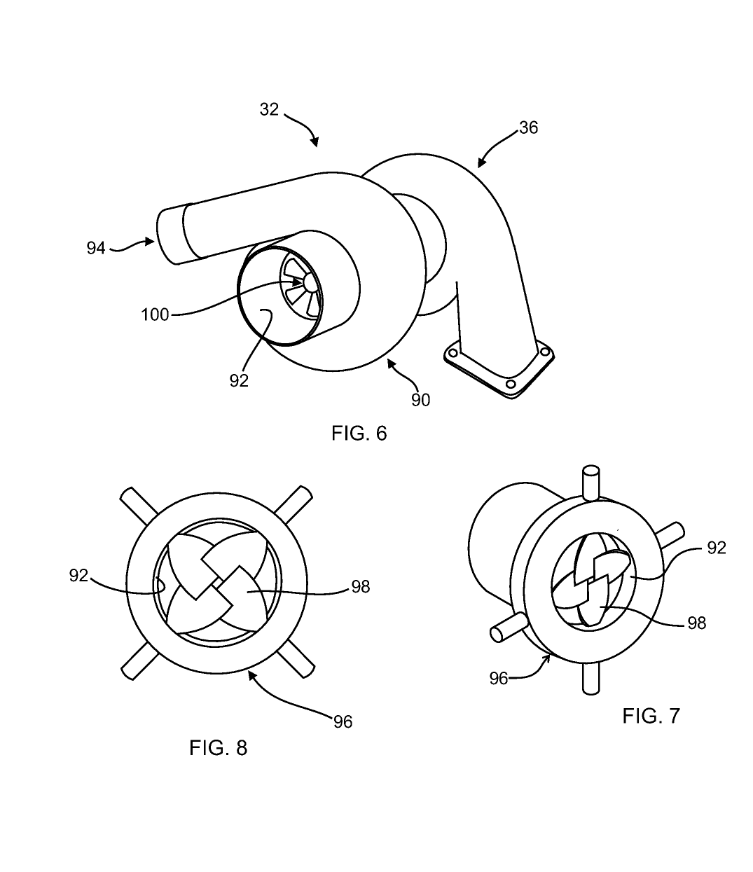

Referring now to FIG. 6, an exemplary boost assist device 32 useful in embodiments of the invention may include a compressor housing 90, housing inlet 92, air compression wheel with associated blades 100 for compressing air, and the drive mechanism 36. Examples of this boost assist device 32 include hydraulically driven systems, electrically driven systems, belt driven systems and pneumatically driven systems. Such devices may be driven directly from the engine 12, such as with a belt or via a hydraulic pump (which may be driven by the engine), or via an alternator (which is driven by the engine). Alternatively, the boost assist device 32 may be driven by stored energy such as in an accumulator or a set of batteries.

Referring now to FIGS. 7-8, the windmilling effect may be enhanced and the speed of the rotating boost assist device 32 may be increased by positioning an intake air swirl device 96 at, in, or near the inlet 92 of the boost assist device 32. In this embodiment of the invention, the swirl device 96 includes a plurality of blades 98 constructed and arranged to direct the intake air in a direction, which increases compressor speed such as by directed passage of air over compressor vanes. For example, the swirl device 96 may direct intake air toward the outer wall of the inlet port 92 and toward the housing wall. However, the invention is not limited to the specific embodiment shown in FIGS. 7-8. Any type of swirl device that enhances the windmilling effect and increases the speed of the rotation of the boost assist device 32 may be used.

The above description of embodiments of the invention is merely exemplary in nature and, thus, variations thereof are not to be regarded as a departure from the spirit and scope of the invention.

What is claimed is:

1. An engine system comprising:
an engine air intake system comprising plumbing for flowing air therethrough comprising a first segment and a boost assist device connected to the first segment, and a bypass line connected to the first segment and constructed and arranged to provide an air bypass path around the boost assist device.

2. An engine system as set forth in claim 1 further comprising a valve in one of the first segment or bypass line constructed and arranged to at least partially allow or at least partially restrict the flow of air through the bypass line.

3. An engine system as set forth in claim 2 wherein the valve is in the bypass line.

4. An engine system as set forth in claim 1 wherein the bypass line is connected to the first segment at a first point and at a second point and wherein the boost assist device is positioned in the first segment between the first point and second point.

5. An engine system as set forth in claim 4 wherein the valve is a 3-way valve positioned at the first point.

6. An engine system as set forth in claim 5 wherein the 3-way valve comprises one inlet and two outlet ports and wherein the valve is constructed and arranged to fully close one or more of the ports, fully open or more of the ports, or partially close one or more of the ports.

7. An engine system as set forth in claim 4 wherein the valve is a 3-way valve positioned at the second point.

8. An engine system as set forth in claim 7 wherein the 3-way valve comprises two inlet ports and one outlet port and wherein the valve is constructed and arranged to fully close one or more of the ports, fully open or more of the ports, or partially close one or more of the ports.

9. An engine system as set forth in claim 1 further comprising a swirl device positioned to swirl air entering the boost assist device.

10. An engine system as set forth in claim 1 further comprising an engine exhaust system and a turbocharger comprising a turbine in the exhaust system and an air compressor in the air intake system, and wherein the first segment includes an open end and wherein the boost assist device is between the open end of the first segment and the air compressor of the turbocharger.

11. An engine system as set forth in claim 1 wherein the boost assist device is constructed and arranged to be driven by at least one of mechanical, electric, pneumatic or hydraulic energy.

12. An engine system as set forth in claim 1 further comprising a valve in one of the first segment or the bypass line, the valve being constructed and arranged to control the flow through at least one of the bypass liner or boost assist device.

13. An engine system as set forth in claim 12 further comprising a controller system for controlling the opening and closing of the valve.

14. An engine system as set forth in claim 13 further comprising an engine speed sensor constructed and arranged to provide input to the controller system regarding the engine speed and wherein the controller system is constructed and arranged to cause the valve to close when the engine speed is within a predetermined range associated with the engine being at or near idle and so that air flows through the boost assist device to windmill the boost assist device.

15. An engine system as set forth in claim 13 further comprising a sensor device comprising at least one of an engine speed sensor, an accelerator sensor, a turbocharger component speed sensor, or an exhaust sensor, the sensor device being constructed and arranged to provide input to the controller system and wherein the controller system is constructed and arranged to control the valve in response to the input from the sensor device.

16. An engine system as set forth in claim 13 further comprising an engine speed sensor constructed and arranged to provide input to the controller system regarding the engine speed and wherein the controller system is constructed and arranged to control the valve in response to the input from the engine speed sensor.

17. A method comprising:
providing a system comprising: an engine intake air system comprising plumbing for flowing air therethrough comprising a first segment and a boost assist device connected to the first segment, and a bypass line connected to the first segment and constructed and arranged to provide an air bypass path around the boost assist device, a valve in one of the first segment or bypass line; and
moving the valve to at least partially allow or at least partially restrict the flow of air through the bypass line.

18. A method as set forth in claim 17 wherein the valve is positioned in the first segment between the first point and the boost assist device or between the boost assist device and the second point.

19. A method as set forth in claim 17 wherein the valve is a 3-way valve positioned at the first point.

20. A method as set forth in claim 19 wherein the 3-way valve comprises one inlet and two outlet ports and wherein the valve is constructed and arranged to fully close one or more of the port, fully open or more of the ports, or partially close one or more of the ports.

21. A method as set forth in claim 19 wherein the valve is a 3-way valve positioned at the second point.

22. A method as set forth in claim 21 wherein the 3-way valve comprises two inlet and one outlet ports and wherein the valve is constructed and arranged to fully close one or more of the ports, fully open or more of the ports, or partially close one or more of the ports.

23. A method as set forth in claim 17 further comprising swirling air into the boost assist device.

24. A method as set forth in claim 17 further comprising an engine exhaust system, and a turbocharger comprising a turbine in the exhaust system and an air compressor in the air intake system, and wherein the first segment includes an open end and wherein the boost assist device is between the open end of the first segment and the air compressor of the turbocharger, and further comprising selective driving the boost assist device to assist the turbocharger compressor in delivering compressed air to the engine.

25. A method as set forth in claim 24 wherein the driving the boost assist comprises delivering at least one of mechanical, electric, pneumatic or hydraulic energy to the boost assist device.

26. A method as set forth in claim 25 further comprising a controller system and controlling the opening and closing of the valve by the controller system.

27. A method as set forth in claim 26 further comprising an engine speed sensor constructed and arranged to provide input to the controller system regarding the engine speed and wherein the controller system is constructed and arranged to cause the valve to close when the engine speed is within a predetermined range associated with the engine being at or near idle and so that air flows through the boost assist device to windmill the boost assist device, and controlling the valve in response to the input.

28. An engine system as set forth in claim 26 further comprising a sensor device comprising at least one of an engine speed sensor, air accelerator sensor, a turbocharger component speed sensor, or an exhaust sensor, the sensor device being constructed and arranged to provide input to the controller system and wherein the controller system is constructed and arranged to control the valve in response to the input from the sensor device, and controlling the valve in response to the input.
